(19) United States
(12) Patent Application Publication
(10) Pub. No.: US 2010/0131633 A1
(43) Pub. Date: May 27, 2010

(54) DEVICE GROUP CONTROL

(75) Inventors: Gregroy Charles Herlein, San Francisco, CA (US); Christopher Lewis Yunker, Mill Valley, CA (US); Kelly Ann Hoinacki, Tiburon, CA (US)

Correspondence Address: Robert D. Shedd, Patent Operations;THOMSON Licensing LLC, P.O. Box 5312, Princeton, NJ, 08543-5312, US

(73) Assignee: Thomson Licensing

(21) Appl. No.: 12/450,564

(22) PCT Filed: Jun. 13, 2007
(86) PCT No.: PCT/US2007/013949

§ 371 Date: Sep. 30, 2009

Related U.S. Application Data
(60) Provisional application No. 60/921,714, filed on Apr. 4, 2007.

(51) Int. Cl. G06F 15/173

(52) U.S. Cl. 709/223

(57) ABSTRACT

Embodiments of the present invention provide a method, apparatus and system for providing device group control including enabling each device of a set of devices to receive a broadcast command, determine if the command applies to the device, and take action if the command applies to the device. In one embodiment of the present invention a unique identifier is determined for each recipient device and the unique identifier for each recipient device for which the communication is intended is included with a broadcast or multicast message. Upon receiving the broadcast or multicast message, each recipient device examines the message for its unique identifier to determine if the communication is intended for the device.

### FIELD OF THE INVENTION

The present invention generally relates to device control and programming and, more particularly, to a method, apparatus and system for controlling networked devices at a group level instead of at an individual lever.

### BACKGROUND OF THE INVENTION

The control of devices of a network typically takes the form of sending specific commands to specific, intended devices. Aggregating such devices into groups typically is accomplished using application software. Such solutions create software complexity and may be unsuitable for a desired system behavior due to the sequential nature of such solutions.

More specifically, controlling devices in groups for presenting audio-visual content is difficult due to the need for highly synchronized media and the distributed nature of most current audio-visual delivery methods and systems. For example, in an advertising environment, to accomplish a desired quality of presentation, many display and control devices are often required. As such, many of the needed control functions—power state, volume level, channel tuning, etc.—need to be controlled on the group level for the devices and not merely on a device by device basis. Performing the control functions for the devices in sequence as typically done with today's technology results in a less than desired experience. For example, commanding a set of devices to tune to a particular channel by commanding them each in sequence may result in each device playing the channel slightly out of synchronization with the others. Commanding each unit in sequence also creates complexity for the control systems implemented. That is in current control systems, instead of simultaneously commanding a group of devices to perform an action to be performed universally, a typical system must sequentially address each device and command it to perform such actions.

As such, there is thus a need for a new method, apparatus and system which overcome the above described deficiencies in the state of the art as well as other related deficiencies and provide device group control.

### SUMMARY OF THE INVENTION

Embodiments of the present invention address the deficiencies of the prior art by providing a method, apparatus and system for providing device group control.

In various embodiments of the present invention, a method, apparatus and system are provided that enables a device to receive a broadcast or multicast command, determine if the command applies to the device, and take action if the command applies to the device.

In one embodiment of the present invention, a method for providing group device control includes determining a unique identifier for at least one recipient device, and including with a broadcast or multicast communication, the identifier for each recipient device for which the communication is intended, where a device examines a received broadcast or multicast communication for its unique identifier to determine if the communication is intended for the device.

In an alternate embodiment of the present invention, an apparatus for providing group device control for a plurality of network devices includes a means for communicating with the network devices, a memory for storing at least control programs, instructions and identifier information and a processor for executing the control programs and instructions. In such an embodiment, the apparatus is adapted to perform the steps of determining a unique identifier for each device or group of devices and including with a broadcast or multicast communication, the identifier for each device or group of devices for which the communication is intended, where a device examines a received broadcast or multicast communication for its unique identifier to determine if the communication is intended for the device.

In an alternate embodiment of the present invention, a network which provides device group control of network devices includes a plurality of network devices and an apparatus for providing device group control of network devices. In one embodiment, the apparatus includes a means for communicating with the network devices, a memory for storing at least control programs, instructions and identifier information, and a processor for executing the control programs and instructions. The processor is configured to perform the steps of determining a unique identifier for each device or group of devices and including with a broadcast or multicast communication, the identifier for each device or group of devices for which the communication is intended. In this described embodiment, a device examines a received broadcast or multicast communication for its unique identifier to determine if the communication is intended for the device.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising;

FIG. 3 depicts an exemplary header for a protocol design in accordance with an embodiment of the present invention; and

FIG. 4 an exemplary base protocol profile in accordance with one embodiment of the present invention;

FIG. 5 depicts an exemplary header for a protocol design in accordance with an alternate embodiment of the present invention; and

FIG. 6 depicts an exemplary base protocol profile in accordance with an alternate embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for enabling each device of a set of devices to receive a broadcast command, determine if the command applies to the device, and take action if the command applies to the device. Although the present invention will be described primarily within the context of a retail advertising network environment, the specific embodiments of the present invention should not be treated as limiting the scope of the invention. It will be appreciated by those skilled in the art and informed by the teachings of the present invention that the concepts of the present invention can be advantageously applied in substantially any broadcast environment for the control and grouping of devices.

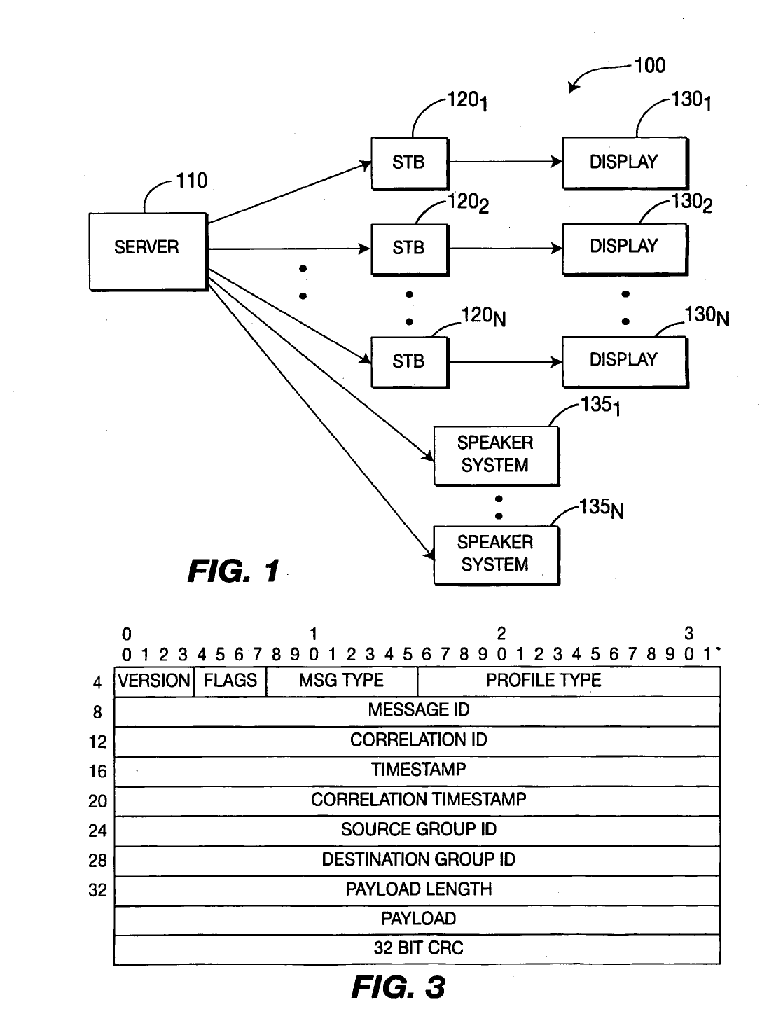

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

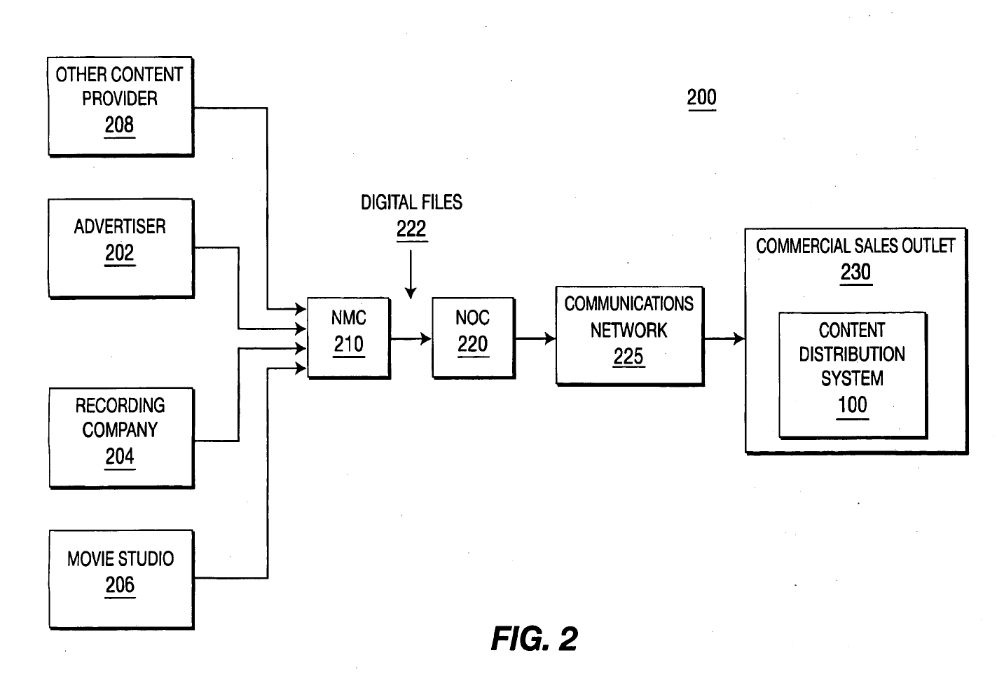

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130 and the speaker systems 135. That is in one embodiment of the present invention, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

In various embodiments of the present invention, one or more of the receivers can be configured to receive a specific one of the created streams and as such forming groups of receivers. In accordance with the present invention, the server 110 implements a control protocol designed for use in, for example, the broadcast (e.g., local area network using layer 2 broadcast) or multicast environment of, for example, the content distribution system 100 of FIG. 1 such that devices, such as the receiving devices of FIG. 1, can be configured in a way that allows the devices to be controlled and/or monitored in groups. That is, in one embodiment of the present invention, the protocol of the present invention targets devices at an ‘application layer’ and not at a ‘network layer’ as is typically done in current systems. Some of the functional parameters of devices that can be controlled in accordance with the present invention can include power state, channel, volume and the like. Although in the embodiment described above, the server 110 is described as a controller for implementing the protocol and inventive aspects of the present invention, in alternate embodiments of the present invention, a separate controller can be provided for implementing the protocol and inventive aspects of the present invention.

In one embodiment of the present invention, each receiver/device is configured to belong to at least one group—itself—and can also belong to many other groups. As such, commands or requests can be targeted by group—which may contain one or a plurality of devices. Each device of a group will, as such, transmit and receive using the same broadcast or multicast channel.

In one embodiment of the present invention, every device automatically belongs to a group of one—its own group based on its id. For example, a device's unicast IP address can be used as its ID. In accordance with the present invention, however, the only requirement for a device's ID is that the device address be unique among that broadcast or multicast address. Devices can support being members of as many groups as desired. In addition, devices can be configured to be members of or not members of groups either by using the protocol or by external means, such as configuration files or other transactions such as (Simple Network Management Protocol) SNMP or web configuration pages. For example, in various embodiments of the present invention, it is possible that a given domain of the present invention can share an IP network with other domains. In addition, it is highly likely that a given domain may wish to enforce message authentication and/or message integrity through the use of an MAC message digest scheme. These two requirements feed the need for the two configurable parameters for a device group control protocol of the present invention such as a MAC shared secret and a Multicast IP address. However, some applications of the present invention may find it highly desirable to also pre-configure group membership. The protocol supports dynamic membership but in some embodiments can add a level of complexity to the control software that limits some of the purpose of the protocol of the present invention. Configuring devices to be part of groups allows the control software to be drastically less complex.

As such, in one embodiment of the present invention, devices are configured to know to which group or groups they belong and when a control/configuration message having group identification information is broadcast or multicast from a server or controller, the device examines the message to determine if the message is intended for a group to which that device belongs. If so, the device processes the control/configuration message. In an alternate embodiment of the present invention, however, a control/configuration message is broadcast or multicast from a server or controller identifying specific devices to which the message applies and each device examines the message to determine if the message is intended for that device.

For example and referring to FIG. 1, in one embodiment of the present invention, the server 110 of the content distribution system 100 receives content and creates various different streams (e.g., content channels) of audio, video and/or audio/video to be distributed to the various devices/receivers such as the set-top boxes 120 and displays 130 and the speaker systems 135. In addition to the received content, the server 110 receives instructions and configuration information for determining what specific received content is intended for which specific devices or groups of devices. In addition to the received content, instructions and configuration information, the server 110 can also receive or determine control information for controlling the configuration of a specific device or group of devices. That is, a server 110 in accordance with the present invention can be used to turn on a group of devices for advertising in a specific location of a retail store or can be used to alter the volume or channel of devices. More specifically, along with content intended for a device or group of devices, a server of the present invention can communicate configuration instructions to a device or group of devices.

For example, suppose that in the content distribution system 100 of FIG. 1 set-top box 120₁ and set-top box 120₂ are installed in a Fashion Department of a retail environment and set-top box 120₃ and set-top box 120₄ are installed in a Food Department of the retail environment. In one embodiment of the present invention, the server 110 having information of the location of the set-top boxes 120 and controlling the content communication communicates a subscription request to the Fashion Department set-top boxes 120₁ and 120₂ to subscribe to a first group having a unique ID number and communicates a subscription request to the Food Department set-top boxes 120₃ and 120₄ to subscribe to a second group having a unique ID number. For example, the server 110 can form the following groups to which the respective set-top boxes can subscribe:

| Group Name | GroupID |
|---|---|
| Fashion | 0x00000001 |
| Food | 0x00000002 |
| All STB | 0x00000003 |

That is, the server 110 communicates a subscribe message to the set-top boxes of the respective groups such that the set-top boxes can become members of the respective groups of which they should belong determined by at least their location and the content and information intended for respective the set-top boxes. As such, when content, instructions or configuration information intended for devices in the Fashion Department is broadcast or multicast by the server 110, the Group ID 0x00000001 is included with the communicated content and information. As such, a set-top box 120 receiving the broadcast examines the received content to determine if that received information is intended for group of which the set-top box is a member. If so, the set-top box determines that the received content is intended for it.

For example, all the STBs within a group can be tuned to a specific IPTV stream from a server. The protocol controller (which may or may not be the server) can then send a single command to the group. For example, the protocol controller can send a command to GroupID 0x00000001 to play a stream having information about new dresses available for purchase and a command to GroupID 0x00000002 to play a stream having information about new soup for sale. These commands can be sent via multicast over the network. The commands can be embedded into the multicast streams already communicated to the STBs, or the commands can be communicated via a new and separate multicast stream. In such a case, all the STBs would receive all of the commands. However, only the two STBs in the Fashion Department—the two that are assigned to group 0x00000001—would execute the commands for that group and tune to the fashion stream. Likewise, only the two STBs in the Food Department—the two that are assigned to group 0x00000002—would execute the commands for that group and tune to the food stream. Similarly, another command can be communicated to all of the STBs—members of group 0x00000003—to tune to still a separate stream. Since all of the STBs are members of group 0x00000003, all of the STBs would execute the command. In addition, optionally, when a STB executes a command addressed to that group, it can communicate a reply to the controller (e.g., server) indicating success or failure. Although it was described in the example above that the server or protocol controller communicates a command to the STBs to become members of respective groups, in alternate embodiments of the present invention, the STBs are pre-configured to belong to predetermined groups and as such the subscribe function does not need to be performed.

In yet an alternate embodiment of the present invention, device groups are not formed at all. For example and referring to FIG. 1, in one embodiment of the present invention, the server 110 of the content distribution system 100 receives content and creates various different streams (e.g., content channels) of audio, video and/or audio/video to be distributed to the various devices/receivers such as the set-top boxes 120 and displays 130 and the speaker systems 135. In addition to the received content, the server 110 can receive instructions and configuration information for determining what specific received content is intended for which specific devices. In addition to the received content, instructions and configuration information, the server 110 can also receive or determine control information for controlling the configuration of a specific device. That is, a server 110 in accordance with the present invention can be used to turn on individual devices for advertising in a specific location of a retail store or can be used to alter the volume or channel of single devices. More specifically, along with content intended for a device or group of devices, a server of the present invention can communicate configuration instructions to a device.

In such an embodiment of the present invention, when content, instructions or configuration information intended for devices is broadcast or multicast by the server 110, the device ID of each of the devices intended to receive the communication is included with the communicated content and information. As such, a set-top box 120 receiving the broadcast examines the received content to determine if that received information is intended for the device by examining the received stream to determine if the unique ID of the set-top box is included with the received communication. If so, the set-top box determines that the received communication is intended for it.

For example, a plurality of STBs can be tuned to a specific IPTV stream from a server. The protocol controller (which may or may not be the server) can send a single command to all of the STBs. For example, the protocol controller can send a command to increase the volume of specific STBs. The command can be sent via multicast over the network. The commands can be embedded into the multicast streams already communicated to the STBs, or the commands can be communicated via a new and separate multicast stream. In such a case, all the STBs would receive the command. The command, however, would include the device IDs of all of the STBs for which the command is intended. When the command is received by a STB (device), the STB examines the received communication to determine if the communication includes its respective device ID and only the STBs whose device ID is included with the command would execute the command of increasing its volume. Furthermore, optionally, when a STB executes a command, it can communicate a reply to the controller (e.g., server) indicating success or failure.

In various embodiments of the present invention, when commands are broadcast or multicast onto a network, the commands will be communicated using a packet scheme. In one embodiment of the present invention, a single command set is configured to fit within one network packet. That is, since packets are broadcast or multicast and most network layer implementations (such as IP) provide only best effort delivery, spreading a command set across more than one packet would complicate the implementation. In such cases, devices would be required to implement a means to either acknowledge individual lost packets or to require the entire message to be resent merely to recover a message fragment. In addition, the protocol would have to be more complicated to support assembling the message in the event that the packets arrived out of order. As such, in accordance with one embodiment of the present invention such complexities are avoided completely by requiring the protocol messages for a command set to fit within one network datagram. For example, on IP networks the basic datagram is a UDP packet whose size is set by the Maximum Transmission Unit (MTU) which is usually 1500 bytes. As such, a command set message communicated using such a protocol must fit within that single datagram.

That is, various embodiments of the protocol of the present invention are intended for use on modern networks (Ethernet LAN, 802.11 wireless, etc.) that do not have small Maximum Transmission Unit (MTU) sizes. Today's networks have an MTU that is usually 1500 bytes. The control messages can fit within one network packet and therefore fit within the MTU minus the network headers. On IP networks the IP and UDP headers comprise 28 bytes. In one embodiment of the present invention, the control message has a 36 byte header and an optional 10 byte hashed message authentication code (HMAC). This leaves over 1400 bytes of payload space per packet on a typical network. Another significant advantage of a datagram based protocol of the present invention is that it is inherently framed by the datagram. As such, a complicated stream synchronization mechanism is not needed to determine the start of a message.

In one embodiment of the present invention, the message format of a command set is binary. That is, while many protocols are implemented in text, using text for the command set of the present invention would risk not fitting messages into a single datagram. In addition, some of the anticipated uses of the present invention are in very low-level embedded systems and simple binary protocols are easily implemented in such systems and consume little system resources in operation.

Embodiments of the present invention support profiles that can be customized for different applications. For example, in one embodiment of the present invention, a profile can include a ‘retail advertising profile’ that defines a set of commands appropriate for a network implemented for advertising in retail stores. In addition, other profiles can support the particular needs of institutions like hospitals, airports, or movie theatres. A profile design of the present invention can include a common header and a variable profile payload. For example, FIG. 3 depicts an exemplary header for a protocol design in accordance with an embodiment of the present invention. The header of FIG. 3 illustratively comprises a version section, a flag section, a message type section, a message ID and correlation ID section, a profile type section, an addressing section, and a timestamp section. FIG. 3 further comprises a payload section and a Cyclic Redundancy Check (CRC) section.

In the header of FIG. 3, the version section provides a means to increment the version number as the protocol evolves. In the example header of FIG. 3, the version is illustratively 0x01. The flag section of the header of FIG. 3 illustratively comprises four bits reserved for flags. The bits are A, B, C and D (from most to least significant in order). In the header of FIG. 3, the A bit is defined to mean ‘Do Not Reply.’ If this flag is set, a device processing the message does not need to reply to the message. All other flag bits are illustratively reserved. In the message type section, the following message types are illustratively defined:

0x01 Request (Command);

0x02 Response;

0x03 Alarm;

All other values are reserved.

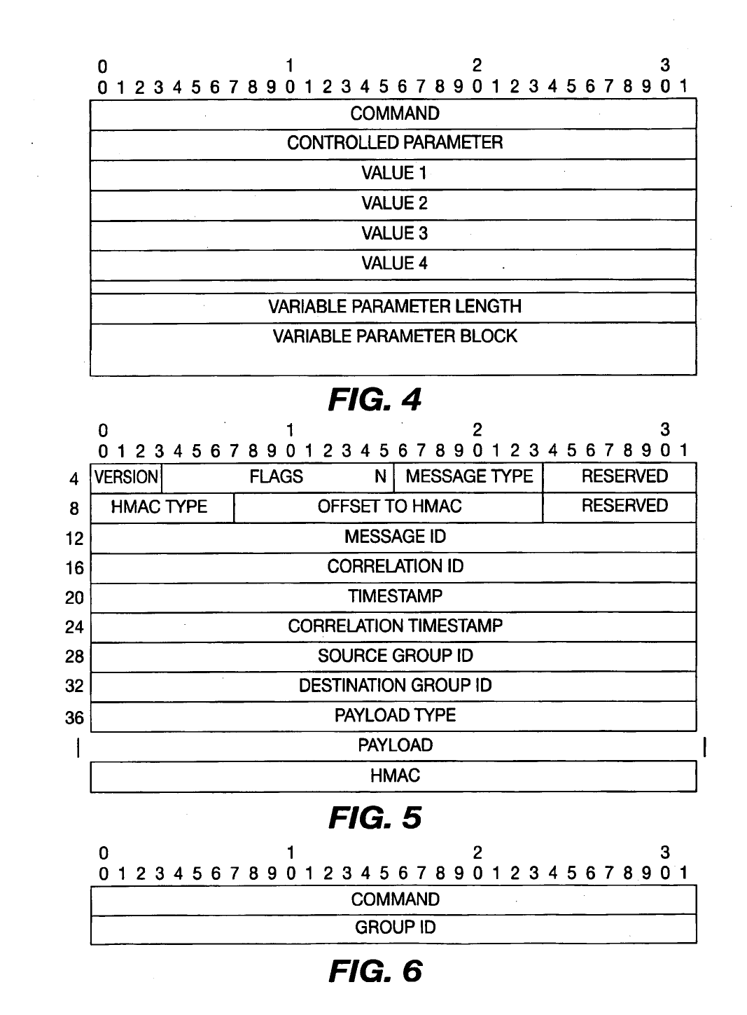

In the message ID and correlation ID section, unless the ‘do not reply’ flag is set, a device that gets a Request message must reply to that message. The reply shall set the correlation id field to equal the message id field of the message being replied to. Request messages shall have the correlation id field set to zero (0). Message IDs shall be initially set to a random value and then incremented by one for each sequential message sent by that device. Prevention of collisions in Message ID numbering is done by the use of the correlation timestamp (described below). In the profile type section, profiles are enumerated. That is, profile types can enumerated for different applications including but not limited to a retail advertising network, a hospital network, airport networks, movie theatres, etc. For example, in the example profile header of FIG. 3, a profile ID of 0 (zero) is defined as the core profile, which is described below with reference to FIG. 4.

The addressing section of the header of FIG. 3 includes ‘Group ID” numbers. That is, as described above, in one embodiment of the present invention, every network device has a unique ID that applies only to that device. However, a given device can be assigned to as many groups as desired. In one embodiment of the present invention, these addresses are 32 bit values.

In the timestamp section of the header of FIG. 3, a timestamp is included. That is, in the embodiment of FIG. 3, the timestamp must be set on all messages sent. In one embodiment of the present invention, the timestamp is a 32 bit value that represents, for example, the number of seconds elapsed since Jan. 1, 1970 (i.e., Unix time). The timestamp of all messages shall be the system time that a request was generated. In one embodiment, initially, the correlation timestamp of all Request messages shall be set to zero (0). The correlation timestamp of all Reply messages shall be the timestamp from the associated Request message. Devices matching reply messages to the Request message must ensure that the correlation timestamp also matches the timestamp of the Request. This prevents collisions in message replies due to random numbers on startup overlapping with previous instances messages.

The payload length section identifies the length of bytes in the payload. Its purpose is strictly to determine the location of the Cyclic Redundancy Check. That is, the Cyclic Redundancy Check section of FIG. 3 includes a 32 bit Cyclic Redundancy Check of all bytes up to and including the last byte of the payload.

FIG. 4 depicts an exemplary base protocol profile in accordance with one embodiment of the present invention. The base protocol profile of FIG. 4 illustratively includes a command section, a controlled parameter section, a plurality of value sections (illustratively four value sections), a variable length section and a variable parameter block section. The base protocol profile of FIG. 4 can be modified in accordance with the present invention to apply to various applications. For example, for a retail advertising application, the command section can include the following commands:

0x01 subscribe to group (in ‘controlled parameter’ field);

0x02 unsubscribe to group (in ‘controlled parameter’ field); and

0x03 unsubscribe to all groups (except self group).

In addition for a retail advertising application, the controlled parameter section can include the following defined values:

0x01 power state;

0x02 channel;

0x03 volume; and

0x04 mute.

The power state values can include a respective “on” (e.g., binary ‘1’) and “off” (e.g., binary ‘0’) value; the channel value can include an indication of whether the channel comprises an IPTV channel (e.g., binary ‘0’) or an RF channel (e.g., binary ‘1’); the volume value can include a number representative of a value between 0 and 100 percent; and the mute value can include a respective “on” (e.g., binary ‘1’) and “off” (e.g., binary ‘0’) value.

In an embodiment of the present invention of the retail advertising example described above, the variable parameter block section can include an IPTV SDP description block that defines the IPTV stream information. This is what would normally be returned in the response to an RTSP DESCRIBE request. For example:

c=IN IP4 233.192.0.101;

a=control:rtsp://169.254.1.1/view0;

a=type: scheduled;

m=video 49162 RTP/AVP 33;

a=fmtp:33 program_number=1;

a=framerate:29.97; and

a=orient: portrait.

In an alternate embodiment of a retail advertising application, the variable parameter block section can include an RF SDP description block that defines the RF stream information. This is what would normally be returned in the response to an RTSP DESCRIBE request.

FIG. 5 depicts an exemplary header for a protocol design in accordance with an alternate embodiment of the present invention. The header of FIG. 5 illustratively comprises a version section, a flag section, a message type section, an HMAC type section, an offset to HMAC section, a message ID and correlation ID sections, a timestamp section, a source group ID and destination group ID sections, and a payload type section. FIG. 5 further depicts a payload section and an HMAC section.

In the header of FIG. 5, the version section provides a means to increment the version number as the protocol evolves. In the example header of FIG. 5, the version is illustratively 0x01. The flag section of the header of FIG. 5 illustratively comprises twelve bits reserved for flags. In the embodiment of FIG. 5, the least significant bit is defined to mean ‘Do Not Reply’ and is called the ‘N’ bit. If this flag is set, a device processing the message does not need to reply to the message. All other flag bits are illustratively reserved. In the message type section, the following message types are illustratively defined:

0x00 Notification

0x01 Request (Command);

0x02 Response;

0x03 Alarm;

All other values are reserved.

The HMAC section, defines the Hashed Message Authentication Code (HMAC) used with the message. The following values are illustratively defined:

0x00 None

0x01 CRC32 (for message integrity only)

0x02 HMAC-MD5 (RFC 2202)—80 bit length

0x03 HMAC-SHA1 (RFC 2202)—80 bit length.

The offset to HMAC section defines an offset from the start of the group protocol frame of the present invention to the first byte of the HMAC. If no HMAC is used this value is ignored.

In the message ID and correlation ID section, unless the ‘do not reply’ flag is set, a device that receives a Request message must reply to that message. The reply shall set the correlation id field to equal the message id field of the message being replied to. Request messages shall have the correlation id field set to zero (0). Message IDs shall be initially set to a random value and then incremented by one for each sequential message sent by that device. Prevention of collisions in Message ID numbering is done by the use of the correlation timestamp (described below).

In the embodiment of FIG. 5, every protocol device has at least one individual address and zero or more group addresses. The individual address is called the ‘Individual ID” and the group addresses are called “Group IDs.” These addresses are illustratively 32 bit values in the embodiment of FIG. 5 and identified in the source group ID and destination group ID sections.

In the timestamp section of the header of FIG. 5, a timestamp is included. That is, in the embodiment of FIG. 5, the timestamp must be set on all messages sent. In one embodiment of the present invention, the timestamp is a 32 bit value that uses the Internet Group Management protocol (IGMP) timestamp format. The 32 bits are an unsigned integer representing the number of milliseconds since midnight Universal time (on the host). The timestamp of all messages shall be the system time that a request was generated. In one embodiment, initially, the correlation timestamp of all Request messages shall be set to zero (0). The correlation timestamp of all Reply messages shall be the timestamp from the associated Request message. Devices matching reply messages to the Request message must ensure that the correlation timestamp also matches the timestamp of the Request. This prevents collisions in message replies due to random numbers on startup overlapping with previous instances messages. For example, it is possible that a controller of the present invention could be operational and issuing messages and then fail and subsequently restart. On restart it is possible that the controller can re-use message ID numbers that have been issued already and not yet responded to. The controller can detect such collisions by verifying that the correlation timestamp also matches the timestamp of the Request.

Another benefit of the reply timestamp is that it can be used as a crude measure of timing for the performance of a given function. Assuming the devices and controller are somewhat time synchronized (using Network Time Protocol for example) then the reply message contains the timestamp from the original request and the reply. The difference between the two is the time required for the closed loop function to be performed (in seconds). This can be useful as a means to easily observe system performance.

Referring back to FIG. 5, the payload type section identifies payload types for different applications including but not limited to a retail advertising network, a hospital network, airport networks, movie theatres, etc. For example, in FIG. 5, the payload types can include the following:

0x00 Core protocol payload (described with respect to FIG. 6);

0x01 Set Top Box Control Payload (described with respect to FIG. 8).

For example, FIG. 6 depicts an exemplary base protocol profile in accordance with an alternate embodiment of the present invention. In one embodiment of the present invention, the command section of the base protocol of FIG. 6 can include the following commands:

0x00 group clear—unsubscribe to all groups (except self group)

0x01 subscribe to group;

0x02 unsubscribe to group;

0x03 enumerate group membership; and

0x04 heartbeat.

The group clear command is used to command a device(s) to specifically forget all group memberships it currently has (except self group. The Subscribe command is used to specifically subscribe a device (or group of devices) to a group. The Unsubscribe command is used to specifically unsubscribe a device (or group of devices) from a group. The Enumerate Group Membership command is used to query a device about to which groups it belongs. In one embodiment of the present invention, each contacted device will reply with a success or failure code and will then send a group membership notification message for each group of which it is a member. It should be noted that if this command is sent to a group rather than an individual device the number of replies could be very large since each device in the group would thus enumerate its group membership. The Heartbeat command is used to send a heartbeat message to a device or device group. Each device in the group must reply. This is a very useful tool to both ensure network connectivity as well as to enumerate group membership.

Referring back to FIG. 6, the group ID section identifies the group that for which the command is to take action. In the case of subscribe or unsubscribe commands, this is the group that is to be subscribed to or unsubscribed from. In the case of a group clear command this field is ignored.

With regards to the base protocol profile of FIG. 6, reply messages must set the command field to, for example, either a 0 (failure) or 1 (success) for the command requested. In addition and with regards to the base protocol of FIG. 6, alarm messages must have the ‘do not reply’ flag set. In one embodiment of the present invention, the command field can be set for the following alarm conditions:

0x00 unable to determine own group id (not configured or other similar error).

Even further and with regards to the base protocol profile of FIG. 6, notification messages must have the ‘do not reply’ flag set. In one embodiment of the present invention, the command field can be set for the following conditions:

0x00 DGCP software stack shutdown;

0x01 DGCP software stack startup; and

0x02 DGCP Group Membership Announcement.

In the embodiment of FIG. 6, the Software Stack Shutdown notification is sent when a device or controller is about to perform a normal shutdown. It provides and indication that the device is going offline. The Software Stack Initialized notification is sent on startup of the device or controller to signal that the device has restarted. If the device is not capable of initializing its group memberships, the controller may need to subscribe the device to the appropriate groups again. The Group Address Announcement notification is used as a means for a device to advertise its group membership. A device can announce its memberships on startup and in response to an “Enumerate Group Membership” command.

Having described various embodiments for a method, apparatus and system for providing device group control including enabling each device of a set of devices to receive a broadcast command, determine if the command applies to the device, and take action if the command applies to the device (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for providing device group control of network devices, comprising:
determining a unique identifier for at least one recipient device; and
including with a broadcast or multicast communication, the identifier for said at least one recipient device for which the communication is intended;
wherein a recipient device examines a received broadcast or multicast communication for its unique identifier to determine if the communication is intended for the recipient device.

2. The method of claim 1, wherein said communication comprises control information.

3. The method of claim 2, wherein said control information is broadcast or multicast using a packet scheme.

4. The method of claim 3, wherein said control information comprises a command set and said command set is configured to fit within one packet.

5. The method of claim 4, wherein said packet comprises a network packet.

6. The method of claim 2, wherein said control information comprises a binary command set.

7. The method of claim 2, wherein said control information comprises command sets intended to control recipient devices in a retail advertising network.

8. The method of clam 2, wherein said control information comprises a common header and a variable profile payload.

9. The method of clam 2, wherein said control information is adapted to control at least one of a power state, channel, and volume of a device intended to receive said control information.

10. The method of claim 1, wherein said determining comprises communicating a subscription message to at least one recipient device for determining a respective unique identifier for each recipient device.

11. The method of claim 1, wherein said determining comprises assigning pre-determined respective identifiers for each recipient device for identifying recipient devices.

12. The method of claim 1, wherein recipient devices for which a communication is intended communicate a reply indicating success or failure of performance of instructions included within said communication.

13. An apparatus for providing device group control of network devices, comprising:
a means for communicating with said network devices;
a memory for storing at least control programs, instructions and identifier information; and
a processor for executing said control programs and instructions, said processor adapted to perform the steps of:
determining a unique identifier for at least one recipient device; and
including with a broadcast or multicast communication, the identifier for each recipient device for which the communication is intended;
wherein a recipient device examines a received broadcast or multicast communication for its unique identifier to determine if the communication is intended for the recipient device.

14. The apparatus of claim 13, wherein said means for communicating comprises a layer 2 broadcast means.

15. The apparatus of claim 13, wherein said means for communicating comprises a multicast means.

16. The apparatus of claim 15, wherein the unique identifier for said at least one recipient device comprises a unicast internet protocol address of each recipient device.

17. A network for device group control of network devices, comprising:
a plurality of network devices; and
an apparatus for providing device group control of network devices, the apparatus including:
a means for communicating with said network devices;
a memory for storing at least control programs, instructions and identifier information; and
a processor for executing said control programs and instructions, said processor adapted to perform the steps of:
determining a unique identifier for each device or group of devices; and
including with a broadcast or multicast communication, the identifier for each device or group of devices for which the communication is intended;
wherein a device examines a received broadcast or multicast communication for its unique identifier to determine if the communication is intended for the device.

18. The network of claim 17, wherein said plurality of devices are pre-configured to belong to predetermined groups.

19. The network of claim 17, wherein said network comprises a local area network and said means for communicating comprises a layer 2 broadcast means.

20. The network of claim 17, wherein said network comprises an internet protocol network and said means for communicating comprises a multicast means.

21. The network of claim 20, wherein the unique identifier for each of said devices comprises a unicast Internet protocol address of each device.
